(19) United States
(12) Patent Application Publication
(10) Pub. No.: US 2006/0017938 A1
(43) Pub. Date: Jan. 26, 2006

(54) Three-dimensional surveying instrument and electronic storage medium

(76) Inventors: Fumio Ohtomo, Tokyo (JP); Hitoshi Ohtani, Tokyo (JP)

Correspondence Address: BAKER & BOTTS, 30 ROCKEFELLER PLAZA, NEW YORK, NY, 10112, US

(21) Appl. No.: 11/152,860

(22) Filed: Jun. 15, 2005

(30) Foreign Application Priority Data
Jun. 15, 2004 (JP) 2004-177650

(51) Int. Cl. G01B 11/24

(52) U.S. Cl. 356/611

(57) ABSTRACT

The present invention relates to a three-dimensional surveying instrument used to calculate three-dimensional coordinate data by use of a surveying instrument and an imaging unit. An object of the present invention is in particular to provide a three-dimensional surveying instrument that determines positions of corresponding points by use of a surveying instrument, and that is capable of stereo displaying. The three-dimensional surveying instrument according to the present invention is capable of: from positions of at least three reference points, which are measured by the surveying instrument, and from an image acquired by the imaging unit, calculating a tilt of the imaging unit, and the like; from a position of a collimation point measured by the surveying instrument, calculating a tilt of the imaging unit, and the like; with the collimation point being used as a corresponding point, performing matching of the image acquired by the imaging unit; associating the position of the collimation point measured by the surveying instrument with a collimation point on the image, the matching of which has been performed; and calculating three-dimensional coordinate data of the target to be measured on the basis of the association.

### BACKGROUND OF THE INVENTION

The present invention relates to a three-dimensional surveying instrument used to calculate three-dimensional coordinate data by use of a surveying instrument and an imaging unit, and more particularly to a three-dimensional surveying instrument that is capable of determining positions of corresponding points by use of a surveying instrument at a surveying site so as to generate data, stereo displaying of which can be performed.

Heretofore, when three-dimensional coordinates are acquired from image data, it is necessary to use, for example, imaging means such as a digital camera, and a reference structure, the dimensions of which are known. The reference structure is placed in proximity to an object that is a target to be measured. Then, this reference structure is imaged by a camera from two directions or from a plurality of directions. This camera is equipped with an inclinometer used to measure a tilt of an image in the front and back, and right and left, directions. Here, the dimensions of the reference structure are known. For example, a triangular structure is used. A position at which imaging is performed by the camera, and a position at which the reference structure is placed, are measured positions. The relative positional relationship between the object to be measured and each of the measured points is known beforehand.

From this imaging position, imaging is performed with such composition that the object as the target to be measured and the reference structure are imaged at the same time. Judging from the reference structure, the imaging position, and a position on an acquired image, the relationship among them is determined by means of absolute orientation so as to calculate three-dimensional coordinates of the object that is the target to be measured.

However, to perform the conventional absolute orientation, the reference structure, the dimensions of which are known, and the like, must be placed beforehand. In addition, a position at which the reference structure is placed, and a position of the camera used for imaging, must also be measured. Placing the reference structure and the camera, and measuring positions thereof, are very troublesome. In the case of a building, or the like, its dimensions are gigantic, which is accompanied by great difficulty. This was the problem to be solved. Moreover, an imaging posture cannot be measured without providing the camera with the inclinometer for detecting a tilt. Such a special camera, therefore, becomes extremely expensive. This was another problem to be solved.

### SUMMMARY OF THE INVENTION

According to the present invention, there is provided a three-dimensional surveying instrument that calculates data used for three-dimensional displaying on a screen such as a display, said three-dimensional surveying instrument comprising: a digital camera for performing stereo imaging; and a surveying instrument (total station) having a distance measuring function used to determine coordinates of corresponding points (path points) of a stereo image.

### BRIEF DESCRIPTION OF THE DRAWINGS

Drawings illustrating embodiments of the present invention will be listed as below.

FIG. 1 is a diagram illustrating a first embodiment of the present invention;

FIG. 2 is a diagram illustrating the first embodiment of the present invention;

FIG. 3 is a diagram illustrating the first embodiment of the present invention;

FIG. 4 is a diagram illustrating the first embodiment of the present invention;

FIG. 5 is a diagram illustrating a surveying instrument 1000 according to the first embodiment;

FIG. 6 is a diagram illustrating a configuration of the surveying instrument 1000 according to the first embodiment;

FIG. 7 is a diagram illustrating another configuration of the surveying instrument 1000 according to the first embodiment; and

FIG. 8 is a diagram illustrating working of this embodiment.

### DESCRIPTION OF THE INVENTION

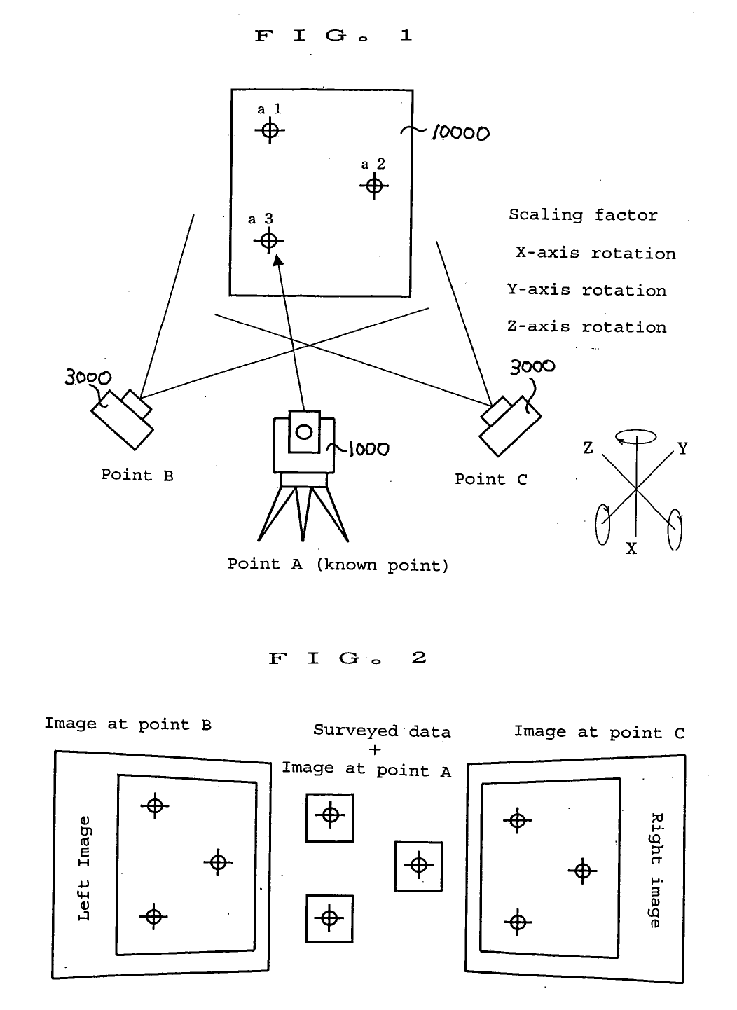

A first embodiment in which a target mark is not used as a path point will be described with reference to FIGS. 1 and 2. In this first embodiment, a surveying instrument 1000 is equipped with an imaging unit 100.

The surveying instrument 1000 comprises the imaging unit 100 capable of inputting an image in a collimation direction. As a distance measuring function, the surveying instrument 1000 has a non-prism function that catches a direct reflection from a natural object, and that does not require a reflecting prism.

As shown in FIGS. 1 and 2, the surveying instrument 1000 collimates an arbitrary part of a target to be measured so that the distance is measured. In addition, the surveying instrument 1000 measures a horizontal angle and an angular height in like manner. Then, the imaging unit 100 acquires an image at a surveying point. Because a collimation point is the center of an optical axis, the collimation point agrees with the center of the image. Because the surveying point becomes a path point, survey values and images at least at three positions are acquired.

After the surveying, images are acquired at least from two directions by use of a digital camera 3000.

Next, image data of the digital camera 3000 is inputted into the surveying instrument 1000 where the stereo image of the digital camera 3000 is matched with the images acquired at three points by use of the surveying instrument 1000. Then, single photo orientation is performed. More specifically, a scaling factor, the luminance, and the rotation, of the stereo image are corrected according to position coordinates at three points. The path point is determined on the basis of the single photo orientation.

After determining a plurality of path points, the data is transferred to, for example, a personal computer placed in an office. Then, mutual orientation is performed to determine the relative relationship between the digital cameras 3000 that have acquired the right and left images respectively. As a result, the relative positional relationship of points forming the target to be measured 10000 is determined. The absolute orientation is performed by use of data based on the mutual orientation so as to convert the data into that in a ground coordinate system. In addition, the data can also be displayed on a screen as an ortho image on the basis of the positional relationship determined by the mutual orientation.

Incidentally, the imaging unit 100 is used to convert data of an image device into digital data. The imaging unit 100 is, for example, a solid-state image sensing device such as a CCD. This imaging unit 100 comprises: an imaging element 110 formed of a CCD, or the like; and an image circuit 120 for generating an image signal from an output signal of the imaging element 110.

### First Embodiment

The first embodiment will be described with reference to FIGS. 1 through 4.

The first embodiment in which a target mark is not used as a path point will be described with reference to FIGS. 1 and 2. In this first embodiment, the surveying instrument 1000 is equipped with the imaging unit 100.

The surveying instrument 1000 comprises the imaging unit 100 capable of inputting an image in a collimation direction. As a distance measuring function, the surveying instrument 1000 has a non-prism function that catches a direct reflection from a natural object, and that does not require a reflecting prism.

The surveying instrument 1000 collimates an arbitrary part of a target to be measured so that the distance is measured. In addition, the surveying instrument 1000 also measures a horizontal angle and an angular height in like manner. Then, the imaging unit 100 acquires an image at a surveying point. Because a collimation point is the center of an optical axis, the collimation point agrees with the center of the image. Because the surveying point becomes a path point, survey values and images at least at three positions are acquired.

This embodiment will be described in detail with reference to FIG. 8. First of all, in a step 1 (hereinafter abbreviated as “S1”), as shown in FIG. 1, the surveying instrument 1000 equipped with an imaging unit is placed at a point A that is a known point. In this embodiment, the imaging unit 100 which is built into the surveying instrument 1000 is adopted as this imaging unit.

Next, in a S2, reference points are measured by use of the surveying instrument 1000. In this embodiment, as shown in FIG. 1, the reference points are a1, a2, and a3; and accordingly the number of the reference points is three. Here, these three reference points a1, a2 and a3 are measured by use of the surveying instrument 1000. At the same time, images including the reference points are picked up by use of the imaging unit 100.

Moreover, in S3, as shown in FIGS. 1 and 2, the digital camera 3000 is moved to a point B, and is then moved to a point C, so as to pick up an image including the reference points. To be more specific, the digital camera 3000 is placed at the points B and C, and the target to be measured 10000 and the image including the reference points a1, a2, a3 are picked up in stereo. As shown in FIG. 2, the stereo image is picked up by the digital camera 3000 from at least two directions (from the right and left directions). It is to be noted that although in this embodiment the stereo image is picked up by moving the digital camera 3000 to those points, a set of stereo cameras may also be separately prepared.

Incidentally, as for the digital camera 3000, it is desirable that the distortion of the image caused by the property of a lens be known beforehand.

After that, in S4, image data which has been acquired by the digital camera 3000 is inputted into the surveying instrument 1000.

Next, in S5, the single photo orientation is performed.

More specifically, the single photo orientation is performed as follows: determining, by use of collinear conditions that hold based on reference points imaged in a piece of photograph, a position (X_{θ}, Y_{θ}, Z_{θ}) of the digital camera 3000 by which a photograph is taken, and a tilt (ω, φ, K; roll, pitch, angle of yaw) of the digital camera 3000; and thereby determining the relationship between photograph coordinates (x, y) and ground coordinates (X, Y, Z).

The position (X_{θ}, Y_{θ}, Z_{θ}) of the digital camera 3000 and the tilt (ω, φ, K; roll, pitch, angle of yaw) of the digital camera 3000 are called external orientation elements. As a result, it is possible to calculate the tilt, a scaling factor, and the like, of the digital camera 3000 from the reference points.

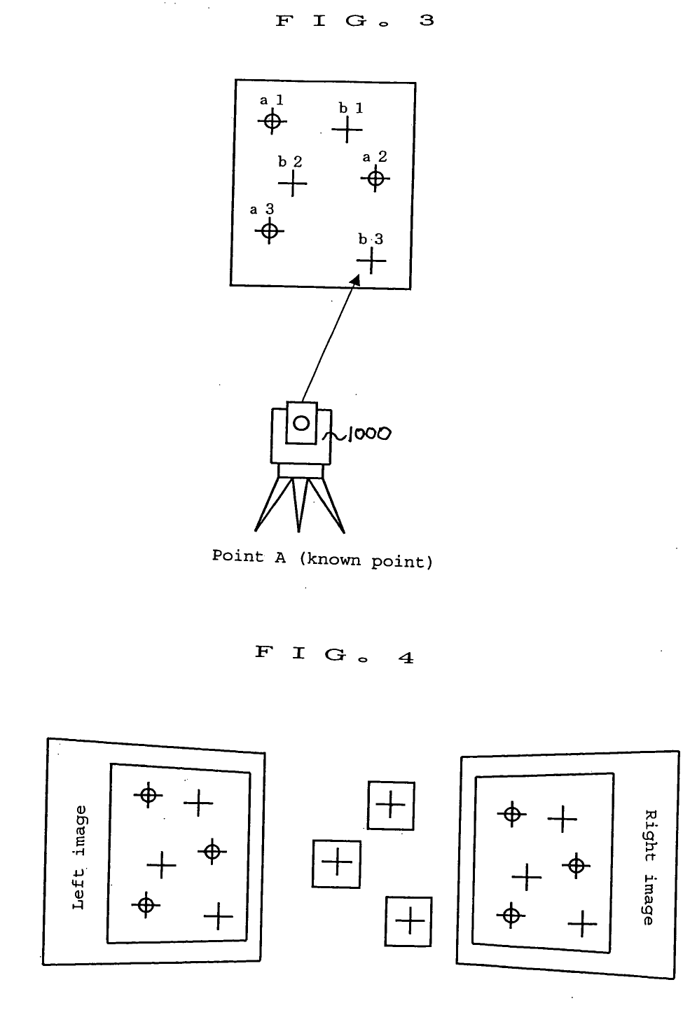

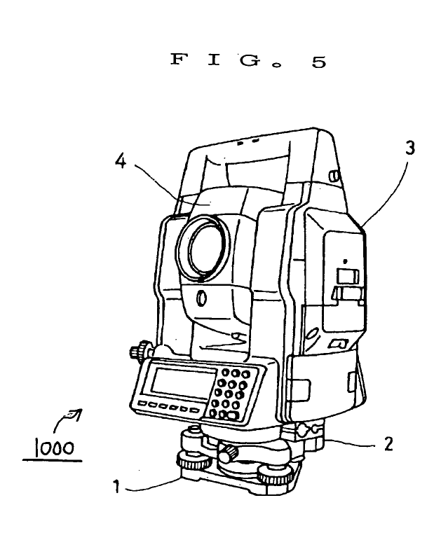

Next, in S6, collimation is performed by the surveying instrument 1000 so that path points to the target 10000 to be measured are generated. To be more specific, the surveying instrument 1000 equipped with the imaging unit is placed at the point A that is a known point, and then the collimation at a desired point is performed. In this embodiment, as shown in FIGS. 3 and 4, collimation points b1, b2 and b3 are collimated so that angle parts of the target 10000 to be measured become path points.

In S7, as the path points, collimation points are generated on the image of the individual digital camera 3000. To be more specific, in the S7, the path points used to perform the mutual orientation are formed. The path points are formed on the stereo image according to the position coordinates at three points. In the case of a plane, six points or more are required to perform the stereo image measurement. In the case of a building, or the like, a large number of points are required for the stereo image measurement if necessary.

Next, in S81, the collimation points (path points) acquired in the S7 are used to perform the mutual orientation. In the S81, it is possible to calculate from the path points the relationship between, for example, the tilt, and the scaling factor, of the stereo image of the digital camera 3000.

After that, in S82, a bias correction image is created. The bias correction image is used to associate the path points of the stereo image with one another. The bias correction image in the S82 is created by slanting shadow conversion. The slanting shadow conversion is such conversion that photograph coordinates at a certain point on a light receiving element of the digital camera 3000 are projected on another plane. Here, feature points are extracted from one image, and then the same horizontal line of another image is searched for corresponding points.

Accordingly, a conversion needs to be made into an image on which a projection is made after the digital camera 3000 is moved in parallel in the horizontal direction. To be more specific, as if the image to be used were picked up after horizontally moving the digital camera 3000, the conversion into the image needs to be made. Such conversion makes it possible to search for the corresponding points even in the case of an image acquired by naturally moving the digital camera 3000. Moreover, in S83, path points are generated manually or automatically.

Then, in S84, stereo matching is performed. This stereo matching is a technique for automatically searching for corresponding points of two images that has been picked up.

Next, in S85, by use of the corresponding points that have been searched for in the S84, it is possible to determine the relative relationship between the digital cameras 3000 that have picked up the right and left images respectively. This makes it possible to define a three-dimensional coordinate system about an optical axis of the left camera.

This makes it possible to define a three-dimensional coordinate system about an optical axis of the one digital camera 3000.

Next, in S86, absolute orientation is performed. To be more specific, coordinate positions of the path points which have been measured by the surveying instrument 1000 are given to a model coordinate system acquired by the mutual orientation so as to convert into the ground coordinate system.

The conversion is made by giving three-dimensional coordinate values measured on the ground to points on the image.

Next, in S87, a conversion into three-dimensional data in the ground coordinate system is made. For example, it is possible to display an ortho image, which is developed on the basis of this data.

Here, the ortho image will be described. A photograph which is taken by a camera is a center projection photograph, whereas a photograph on which a normal oblique projection of the center projection photograph is made is called an orthophoto. Here, in the case of a map, a scale on the map is uniform. However, because the center projection photograph is taken through a lens, a scale on the photograph is not uniform as a whole. In contrast to this, because the orthophoto is based on the normal oblique projection, a scale on the orthophoto is uniform. Accordingly, the orthophoto can be handled in the same manner as that of the map.

An image of the digital camera 3000 is constituted of data, the unit of which is pixel. As a result of the mutual orientation and the absolute orientation, each pixel is provided with coordinates. In the case of two-dimensional displaying by use of a display, or the like, shading is added to the two-dimensional displaying in response to three-dimensional coordinates. At the time of coordinate conversion, coordinates are newly calculated on a pixel basis, and the calculated coordinates are then displayed as operation such as rotation.

As described above, the first embodiment relates to a three-dimensional surveying instrument that calculates three-dimensional coordinate data by use of the surveying instrument 1000 and the digital camera 3000, and that is capable of displaying the three-dimensional coordinate data in stereo.

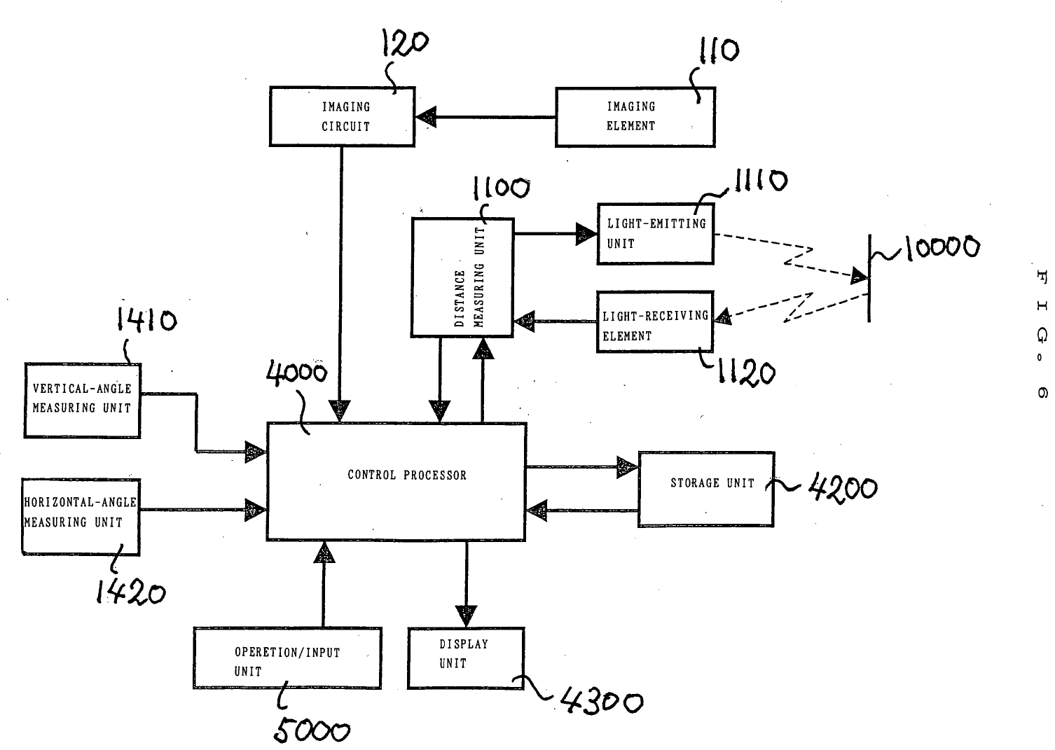

As shown in FIGS. 4 and 5, the surveying instrument 1000 is a total station, which comprises an electronic theodolite for detecting angles (a vertical angle and a horizontal angle), and a light-wave range finder.

It is to be noted that, in this embodiment, the surveying instrument 1000 and the digital camera 3000 are separately configured.

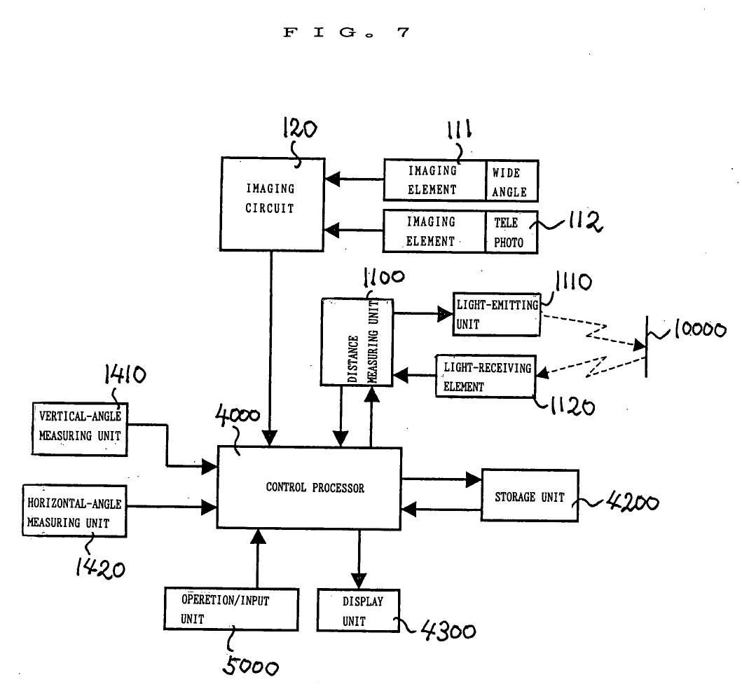

Next, an electric configuration of the surveying instrument 1000 according to this embodiment will be described with reference to FIG. 6.

The surveying instrument 1000 comprises a distance measuring unit 1100, an angle measuring unit 1400, a storage unit 4200, a display unit 4300, a control processor 4000, and an operation/input unit 5000. Here, the storage unit 4200 is used to store data, programs, and the like. The display unit 4300 and the operation/input unit 5000 enable users to operate the surveying instrument 1000.

The distance measuring unit 1100 uses the light-wave range finder. The distance measuring unit 1100 is used to measure the distance to a target to be measured on the basis of, for example, the phase difference, and the time difference, of reflected light. The distance measuring unit 1100 comprises a light emitting unit 1110 and a light receiving unit 1120. The light emitting unit 1110 emits a distance measuring light beam in a direction of the target to be measured. A light beam reflected from the target to be measured enters into the light receiving unit 1120, and thereby the distance to the target to be measured can be measured.

To be more specific, the distance from the surveying instrument 1000 to the target to be measured is calculated by the time difference from a point of time at which the light emitting unit 1110 emits pulses of light until the light receiving unit 1120 receives the pulses of light. It is to be noted that this arithmetic operation is executed by the control processor 4000.

The angle measuring unit 1400 is used to calculate a horizontal angle and an angular height. The angle measuring unit 1400 comprises a vertical-angle angle measuring unit 1410 and a horizontal-angle angle measuring unit 1420.

The vertical-angle angle measuring unit 1410 can detect the amount of up and down rotation as the level or the zenith by use of, for example, an angular height encoder. As for the horizontal-angle angle measuring unit 1420, for example, a horizontal angle encoder can detect the amount of horizontal rotation relative to a reference direction. These encoders comprises, for example, a rotor mounted on a pivoting unit, and a stator including a fixed unit.

It is so devised that the angle measuring unit 1400, which comprises the vertical-angle angle measuring unit 1410 and the horizontal-angle angle measuring unit 1420, calculates a horizontal angle and an angular height on the basis of the detected amount of horizontal rotation and the detected amount of up and down rotation.

The surveying instrument 1000 is equipped with the imaging unit 100 that includes an imaging element 110 and an image circuit 120. This imaging unit 100 may be configured to be built into the surveying instrument 1000, or may also be configured as a separate unit that is connected to the surveying instrument 1000.

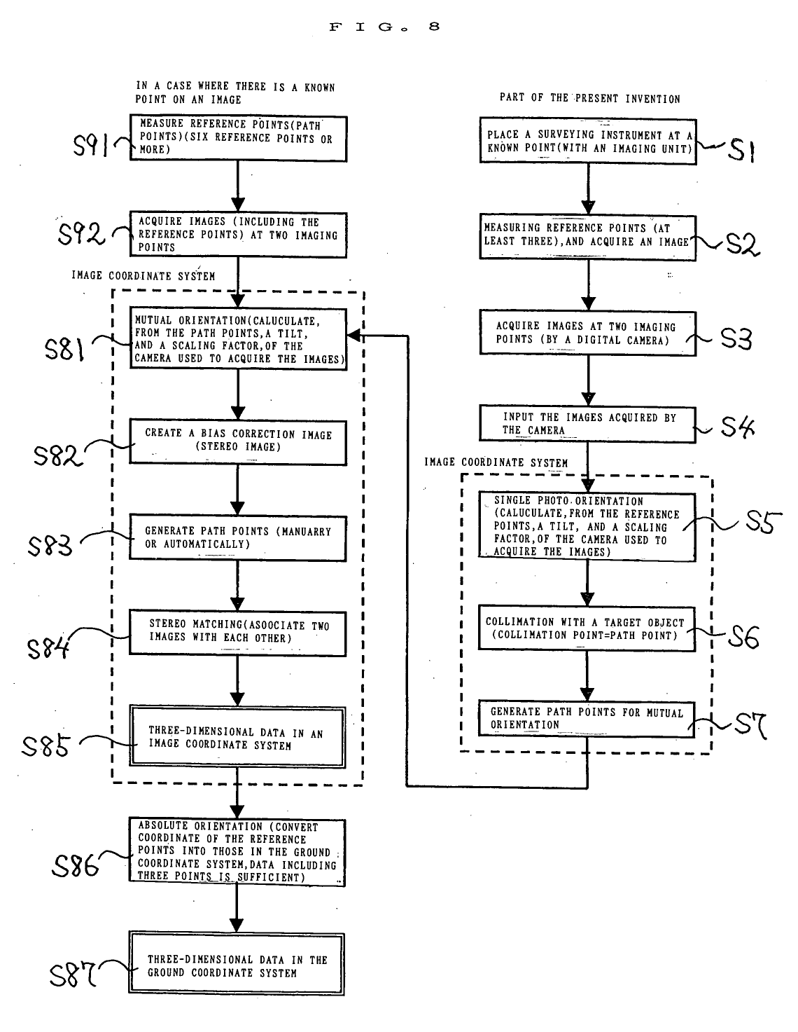

Incidentally, as shown in FIG. 7, the imaging unit 100 can also be configured to be switchable between a wide-angle imaging element 111 and a telephoto imaging element 112. The wide-angle imaging element 111 is a sensor capable of imaging over a wide range, whereas the telephoto imaging element 112 is a sensor capable of acquiring a finder image.

The control processor 4000 includes a CPU. The control processor 4000 executes, for example, various kinds of arithmetic operation.

It is to be noted that a program which describes operational steps to be performed by the operation unit 1300 of the surveying instrument 1000 can be stored in an electronic storage medium such as a FD, a CD, a DVD, a RAM, a ROM, and a memory card.

As shown in FIG. 4, the surveying instrument 1000 comprises: a telescope unit 4; a frame 3 for supporting the telescope unit 4 so that the telescope unit 4 can pivot up and down; and a base 2 for supporting the frame 3 so that the frame 3 can pivot horizontally. The base 2 can be connected to a tripod, or the like, through a leveling plate 1.

In the surveying instrument 1000, an operation panel which is part of the operation/input unit 5000 is formed. In addition, a display which is part of the display unit 4300 is attached to the surveying instrument 1000. Moreover, an objective lens is exposed in the telescope unit 4.

Incidentally, if there is a known point on an image, six reference points are required. However, processing as shown in FIG. 7 is also possible. To be more specific, in S91, reference points are measured. Then, in S92, an image including the reference points is acquired, before proceeding to the S81.

### Second Embodiment

A second embodiment relates to a three-dimensional surveying instrument that uses target marks for three reference points that become path points.

A total station capable of measuring the distance to a reflecting prism which is placed at the reference points is used as the surveying instrument 1000. In addition, instead of the reflecting prism, it is also possible to use such a target mark that a mark is drawn on a reflection sheet.

Incidentally, an example of the relationship between data measured by the surveying instrument 1000 and an image acquired by the digital camera 3000 will be described as below.

$$x = - f \frac{{a}_{11} ( X - Xc ) + {a}_{12} ( Y - Yc ) + {a}_{13} ( Z - Zc )}{{a}_{31} ( X - Xc ) + {a}_{32} ( Y - Yc ) + {a}_{33} ( Z - Zc )} \\ y = - f \frac{{a}_{21} ( X - Xc ) + {a}_{22} ( Y - Yc ) + {a}_{23} ( Z - Zc )}{{a}_{31} ( X - Xc ) + {a}_{32} ( Y - Yc ) + {a}_{33} ( Z - Zc )} \qquad Equation 1$$

where: f is the focal length of the digital camera 3000; a is (ω, φ, K—roll, pitch, angle of yaw), which is a tilt (rotation angles of three axes) of the digital camera 3000; (X, Y, Z) is three-dimensional data measured by the surveying instrument 1000; and (Xc, Yc, Zc) are position coordinates of the digital camera 3000 relative to the surveying instrument 1000.

A base of the target mark is formed of a retroreflection sheet. A cross line indicating a collimation point, and a circle about the cross line, are drawn on the sheet. This circle makes the collimation easy in like manner. A bar code is drawn above the circle so that reading can be performed easily when a conversion into an image is made. A number is drawn below the circle so that a measurer can identify the target mark.

An adhesive is affixed to the back side of this target mark. This adhesive can be affixed to an arbitrary object. In addition, the target mark may also be combined with other affixing means other than the adhesive. For example, the target mark can also be affixed to a magnet on the sheet.

Incidentally, the target mark corresponds to a collimation target; and the circle about the cross line corresponds to a mark that makes the collimation easy.

The other configurations, working, and the like, of the second embodiment are similar to those described in the first embodiment except that the prism is used to measure the reference points. Therefore, the description thereof will be omitted.

Incidentally, image coordinates can also be converted into photograph coordinates. From these photograph coordinates, ground coordinates are calculated by use of a projective transformation equation. From these ground coordinates, photograph coordinates of a search image are determined by use of an inverse transformation equation of the projective transformation. It is also possible to search for a corresponding point by converting the photograph coordinates of the search image into image coordinates, and then by making use of a proper matching method.

Further, it is also possible to convert point data expressed as random three-dimensional coordinates into DEM (DIGITAL ELEVATION MODEL). To be more specific, the point data expressed as random three-dimensional coordinates is converted into data of triangulated irregular network (TIN), and then this TIN data is converted into DEM (DIGITAL ELEVATION MODEL) in a mesh formed of tetragonal lattices.

The three-dimensional surveying instrument according to the present invention, which is configured as above, comprises:
a surveying instrument for measuring a position of a collimation target from the distance and an angle;
an imaging unit for acquiring, from a plurality of different directions, an image of a target to be measured including the collimation target; and
an arithmetic processing means for:
   from positions of at least three reference points, which are measured by the surveying instrument, and from the image acquired by the imaging unit, calculating a tilt of the imaging unit, and the like;
   from the position of the collimation point measured by the surveying instrument, calculating a tilt of the imaging unit, and the like;
   with the collimation point being used as a corresponding point, performing matching of the image acquired by the imaging unit;
   associating the position of the collimation point measured by the surveying instrument with a collimation point on the image, the matching of which has been performed; and
   calculating three-dimensional coordinate data of the target to be measured on the basis of the association.

Accordingly, an effect of acquiring correct three-dimensional coordinate data simply and easily is produced.

What is claimed is:

1. A three-dimensional surveying instrument comprising:
a surveying instrument for measuring a position of a collimation target from the distance and an angle;
an imaging unit for acquiring, from a plurality of different directions, an image of a target to be measured including the collimation target; and
an arithmetic processing means for:
from positions of at least three reference points, which are measured by the surveying instrument, and from the image acquired by the imaging unit, calculating a tilt of the imaging unit, and the like;
from the position of the collimation point measured by the surveying instrument, calculating a tilt of the imaging unit, and the like;
with the collimation point being used as a corresponding point, performing matching of the image acquired by the imaging unit;
associating the position of the collimation point measured by the surveying instrument with a collimation point on the image, the matching of which has been performed; and
calculating three-dimensional coordinate data of the target to be measured on the basis of the association.

2. A three-dimensional surveying instrument according to claim 1, wherein:
the surveying instrument which is placed at a known point measures positions of at least three collimation points; and
the arithmetic processing means corrects the tilt, a scaling factor, and the like, of the imaging unit, and then determines a position of the imaging unit from the position of the collimation point and the image acquired by the imaging unit, and thereby calculates three-dimensional coordinate data of the target to be measured, which is acquired by the imaging unit.

3. A three-dimensional surveying instrument according to claim 1, wherein:
the surveying instrument which is placed at a known point measures positions of at least three collimation points; and
the arithmetic processing means corrects the tilt, a scaling factor, and the like, of the imaging unit, and then determines coordinates of reference points from the position of the collimation point and the image acquired by the imaging unit to convert the coordinates of the reference points into those in a ground coordinate system, and thereby calculates three-dimensional coordinate data of the target to be measured.

4. A three-dimensional surveying instrument according to claim 1, wherein:
a path point which is a collimation point is generated manually or automatically.

5. A three-dimensional surveying method comprising:
a first step of measuring a position of a collimation target from distance data and angle data acquired by a surveying instrument;
a second step of acquiring, from different directions, an image including the collimation target by a plurality of imaging units;
a third step of calculating a tilt of the imaging unit, and the like, from positions of at least three reference points, which are measured by the surveying instrument, and from an image acquired by the imaging unit;
a fourth step of calculating a tilt, and the like, of the imaging unit from the position of the collimation point measured in the first step;
a fifth step of performing matching of the image acquired by the imaging unit with the collimation point being used as a corresponding point;
a sixth step of associating the position of the collimation point measured by the surveying instrument with a collimation point on the image, the matching of which has been performed; and
a seventh step of calculating three-dimensional coordinate data of the target to be measured on the basis of the association acquired in the sixth step.

6. A three-dimensional surveying instrument comprising:
a surveying instrument for measuring a position of a collimation target from the distance and an angle, and for acquiring an image including the collimation target;
an imaging unit for acquiring, from a plurality of different directions, an image of a target to be measured including the collimation target; and
an arithmetic processing means for:
from positions of at least three reference points, which are measured by the surveying instrument, and from the image acquired by the imaging unit, calculating a tilt of the imaging unit, and the like;
from the position of the collimation point measured by the surveying instrument, calculating a tilt of the imaging unit, and the like;
with the collimation point being used as a corresponding point, performing matching of the image acquired by the imaging unit;
associating the position of the collimation point measured by the surveying instrument with a collimation point on the image, the matching of which has been performed; and
calculating three-dimensional coordinate data of the target to be measured on the basis of the association.

7. An electronic storage medium such as a FD, a CD, a DVD, a RAM, a ROM, and a memory card, in which a program is stored, said program instructing the steps of:
reading out distance data, and angle data, of a collimation target, which are measured by a surveying instrument;
reading out image data including the collimation target, which is acquired by a plurality of imaging units from different directions;
from measured positions of at least three reference points and the image acquired by the imaging unit, calculating a tilt of the imaging unit, and the like;
from the position of the collimation point measured by the surveying instrument, calculating a tilt of the imaging unit, and the like;
with the collimation point being used as a corresponding point, performing matching of the image acquired by the imaging unit;
associating the position of the collimation point measured by the surveying instrument with a collimation point on the image, the matching of which has been performed; and
calculating three-dimensional coordinate data of the target to be measured on the basis of the association.
